(19) United States
(12) Patent Application Publication
(10) Pub. No.: US 2004/0089609 A1
(43) Pub. Date: May 13, 2004

(54) Method of improving the handleability of semi-fluid materials

(76) Inventor: Ronald John Coleman, Sydney (AU)

Correspondence Address: Jacobson & Johnson, Suite 285, One West Water Street, St. Paul, MN, 55107-2080, US

(21) Appl. No.: 10/292,776

(22) Filed: Nov. 13, 2002

(51) Int. Cl. C02F 1/28

(52) U.S. Cl. 210/689; 210/770

(57) ABSTRACT

There is a method for increasing the viscosity of a high moisture content semi-fluid material such as sludge, slurry or filter cake so that the handleability is improved for disposal or further processing. The method includes the step of adding to the material a cross-linked copolymer produced from either the copolymerisation of acrylic acid or acrylamide and acrylate salts. The cross-linked copolymer has a high affinity for water so that the moisture content is substantially transferred from the material to the copolymer.

This invention relates to materials handling. More particularly although not exclusively it discloses a process for improving the handleability of moisture laden and semi-fluid industrial by-products containing a high proportion of fine particles.

The following definitions apply to terms used in this specification.

Slurry—This is a liquid containing varying amounts of solid material which will flow readily under its own weight and seek a level as water does in a tank.

Sludge—This is a very viscous semi-fluid containing higher amounts of solids than a slurry which will not readily flow under its own weight. Sludges which do not flow to an acceptable extent under their own weight are a subject of this application.

Friable—This refers to a material which is easily broken into smaller pieces.

Thixotropy—This is a property exhibited by certain gels whereby they become liquid when stirred or shaken.

Rheology—This means the study of the deformation and flow of matter.

Reject Material—This is a material typically consisting of varying proportions of coarse reject (greater than 2 mm) and fines reject (less than 2 mm) which may be combined or handled separately. Each reject stream varys in water content and fluidity.

Activities such as mining and mineral processing etc. produce large volumes of moisture laden filter cakes, sludges and slurries containing high proportions of fine particles. These have to be readily handled for further processing or disposal by emplacement in heaps as landfill. Excessive moisture between the fine particle material can however act as a lubricant which can cause the mass to flow under its own weight. In order to transport high moisture content mining slurries for example, the material is normally loaded onto trucks or conveyor belts. If the slurry is sufficiently fluid some of it will pour out of the truck and obstruct roadways or, in the case of conveyors, flow back down and over the edges of the belt. The cost of cleaning and removal of such spills can be substantial. Further, at the discharge point the slurry tends to spread out of control and flow over the ground rather than forming a steep stable pile.

In the case of sludges which contain valuable minerals further furnace processing may require that the material be first dried in say fluidising beds. Again sludges having a low viscosity and high moisture content can cause problems by blocking the hot gas vents of the fluid drier. While it is known that the sludge or filter cake can be stiffened by blending with dry materials of similar composition this can be time consuming, expensive and not always practical. A typical annual cost of a blending operation may be hundreds of thousands of dollars.

It is therefore an object of this invention to ameliorate the aforementioned disadvantages and accordingly a method is disclosed for increasing the viscosity of a high moisture content semi-fluid material such as a sludge, slurry or filter cake whereby the handleability thereof is improved for disposal or further processing, the method including the step of adding to said material a cross-linked copolymer produced from either the copolymerisation of acrylic acid or acrylamide and acrylate salts said cross-linked copolymer having a high affinity for water whereby said moisture content is substantially transferred from said material into said copolymer and lubrication between particles of the material is reduced.

Preferably the copolymer is used in three forms:—

| | | |
|---|---|---|
| 1. Fine particle | <0.3 mm | (typical) |
| 2. Powder | 0.3-1.0 mm | (typical) |
| 3. Granular | 0.5-3.15 mm | |

The fine power yields the optimum result.

It is further preferred that the copolymer is metered into the material stream using a suitable variable speed screw or vibrating feeder or by hand in a manner whereby dispersion is maximised and a even distribution is obtained throughout said material stream.

Subsequent mechanical mixing of the material may also be beneficial.

In the case of mine tailings produced from ore processing the material typically comprises varying proportions of a course reject (>2 mm). a fine reject (<2 mm and >0.5 mm) and slimes (<0.5 mm). Each of these reject streams varies in moisture content and fluidity. In some cases there may only be fine reject and/or slimes material.

One preferred method of applying the copolymer is by direct addition to a conveyor system using a screw feeder and supply hopper capable of variable delivery rates. Feeders of any suitable design, capable of dosing dry material may also be used.

The currently preferred copolymer is powdered or granulated and is formed by the polymerization of mixtures of acrylic acid acrylamide and acrylate salts. The polymerization reaction is controlled to cause the monomers to cross-link and become insoluble. At this stage however the invention is not limited to any specific mechanism for the moisture absorption.

The preferred particle size is 0.010 mm to 3.15 mm.

The copolymer preferably has a maximum absorption in DI water solution (in W/W) of greater than 100.

The dose rates may vary from 10 to 10,000 grams per tonne of material depending upon the nature of the solids, water content and the application.

Suitable copolymers for use with the method of this invention can be obtained from a range of chemical manufacturers such as SNF Australia Pty. Ltd. of Geelong Victoria under the trade name “Aquasorb Series”.

### EXAMPLE NO. 1

In major mining operations such as Open Cut Coal considerable variations occur in the strata through which the coal or ore seam passes. While the moisture content of the waste material or ore can normally be reduced to a satisfactory and acceptable level by standard filteration methods prior to returning to landfill or further processing major difficulties are experienced when a much higher proportion of fine particles or clays are encountered. In this case the fine particles form a mass in which the percentage of moisture trapped is much higher than normal due to the size distribution. Such material is extremely difficult to dewater by conventional means. This type of mass can also exhibit thixotropic characteristics. Invariably this process stream upon discharge from the processing plant is fed onto conveyors where blending with a coarse waste fraction takes place. It is then transferred into large hoppers which feed dump trucks carrying up to 200 tonne loads for landfill.

Although blended with coarser waste, the fluid nature of the material can still result in considerable spillage from conveyors and trucks. Thixotropic characteristics where a partial solid becomes more free flowing with extra mixing and energy aggravates this problem. It is also important that the reject material used for landfill and rehabilitation should compact readily and be capable of forming steep stable piles for placement rather than spreading over the ground.

The safety aspect of spillage from conveyors and trucks on haul roads is also of major concern apart from the cost of cleanup operations. Furthermore there is a stability hazard for trucks on bends where the load can become unstable and shift.

Extended trials based on a copolymer of acrylamide and acrylate salts have shown that the distribution of a coss-linked polymer through the reject at an average of 0.31 kilograms per tonne overcomes the above problems. The absorption of excess moisture is sufficient to yield a stable product which can be handled easily and safely with conventional equipment.

The said copolymer was added or applied using a variable speed screw feeder fed from a 3 cubic metre hopper. The chemical was added directly onto the conveyor belt with the filter cake. Satisfactory mixing was obtained by tumbling at subsequent transfer stations.

The following specific advantages have been noted:

less splashing, spillage and mess under the reject bin,

loading of the trucks to near maximum capacity was possible,

spillage was eliminated on haul roads and ramps,

controlled discharge from the truck was possible,

there was no free water or slurry to bog the trucks,

the material maintained its form and was workable within hours of deposition, and

the material could withstand pressure and support a load within two weeks of deposition.

### EXAMPLE NO. 2

At a copper smelter serious delays occured at the main metal recovery unit after changes were made to the process. These changes resulted in a much higher proportion of fine particles reporting to the process stream feeding the vacuum filters. This resulted in the filters producing a much wetter filter cake that was then fed to the fluid bed driers. This in turn caused frequent blockage of the hot gas entry vents and repeated unit stoppage for cleaning.

For the efficient operation of fluid bed driers it is essential that the feed material be friable. It must be capable of being broken into small lumps during the drying process. Excess residual moisture inhibits this process.

Previously the local concentrator had sent a coarser fraction of copper concentrate slurry to the filter feed tank. Upon closure of the concentrator however the filter feed was made up of scrubbed dust and precipitated solids composed of oxides and hydroxides of copper and magnesium.

Due to the absence of the coarse fraction the filter feed solids fell to a level of 25% yielding a cake moisture of 30% to 40%. The original feed from the concentrator was 35% solids with a cake moisture of 10% to 15%.

A cross-linked copolymer based on acrylic acid with a particle size range of 0.3 to 1.0 mm was added to the filter cake prior to feeding to the fluid bed dryers. This resulted in a considerable reduction in the residual moisture in the cake. It was in fact reduced to a acceptable level of 15% which lead to the resumption of the high performance and continuous production of the fluid bed driers.

The copolymer was added to the filter cake discharge conveyor belt. Satisfactory mixing was obtained by tumbling at subsequent transfer points prior to feeding or entry to the fluid bed drier.

At normal production of about 150 tonnes per day of filter cake substantial cost savings (including energy savings on the filters) resulted. CL EXAMPLE NO. 3

In underground mining problems occur with collection and removal of wet slurries. These materials are commonly known as “Swillies”. They tend to collect at the bottom of tunnel slopes. They are typically composed of water and claysetc. and can be too viscous for removal by pumping yet too fluid to be handled by a front end loader. These slurries or swillies may interfere with access by personnel and equipment areas and thus inhibit mine operation.

Trials have shown that the addition of a cross-linked copolymer to slurries of this type absorb sufficient water that the material can be removed by shovels or front end loaders.

It will thus be appreciated that this invention at least in the form of the embodiment disclosed provides a novel and relatively low cost method of increasing the viscosity and handleability of sludges slurries and filter cakes. Clearly however the example described is only the currently preferred form of the invention and modifications may be made which would be apparent to a person skilled in the art. For example the amount of moisture absorbing copolymer used as well as the means of distribution through the material may be varied according to application.

The claims defining the invention are as follows:

1. A method for increasing the viscosity of a high moisture content semi-fluid material such as sludge, slurry or filter cake whereby the handleability thereof is improved for disposal or further processing the method including the step of adding to said material a cross-linked copolymer produced from either the copolymerisation of acrylic acid or acrylamide and acrylate salts, said cross-linked copolymer having a high affinity for water whereby said moisture content is substantially transferred from said material into said copolymer.

2. The method as claimed in claim 1 wherein said copolymer is in a powder or granulated form.

3. The method as claimed in claim 2 wherein said copolymer has a particle size of 0.010 mm to 3.15 mm.

4. The method as claimed in claim 3 wherein the copolymer has a maximum absorption in DI water solution (in W/W) of greater than 100.

5. The method as claimed in claim 4 wherein the dose rate of said copolymer is about 10 to 10,000 grams per tonne of said material.

6. The method as claimed in claim 5 wherein the copolymer is added to said material by direct addition to a conveyor system using a screw feeder, supply hopper or by hand.

7. The method as claimed in claim 6 and including the further step of subsequent mechanical mixing of the material.
